(19) United States
(12) Patent Application Publication
(10) Pub. No.: US 2013/0022758 A1
(43) Pub. Date: Jan. 24, 2013

(54) Method and Resulting Device for Processing Phosphor Materials in Light Emitting Diode Applications

(71) Applicant: Troy A. Trottier, San Jose, CA (US)

(72) Inventor: Troy A. Trottier, San Jose, CA (US)

(73) Assignee: Soraa, Inc., Fremont, CA (US)

(21) Appl. No.: 13/359,846

(22) Filed: Jan. 27, 2012

(51) Int. Cl. B05D 5/06

(52) U.S. Cl. 427/565; 427/162; 427/157

(57) ABSTRACT

A method for processing phosphors for use in optical applications includes providing a luminescent material in particulate form. The luminescent material has particles within a size range. A filter process removes particulates having a size greater than two times an upper limit of the size range to separate the particles by the desired particle size range.

### BACKGROUND OF THE INVENTION

This invention relates generally to lighting techniques. More specifically, the invention provides techniques for cleaning phosphors before disposing them on LED devices. The invention can be applied to applications such as white lighting, multi-colored lighting, lighting for flat panels, other optoelectronic devices, and the like.

Phosphor particles are widely used to convert light emission from LED devices to white light. Examples of LED devices include those manufactured using GaN materials. The LED devices often produce electromagnetic radiation in wavelengths ranging from about 400 nm to about 480 nm, i.e. blue and violet colors. The colors must often be converted into white light for use in standard lighting applications.

### BRIEF SUMMARY OF THE INVENTION

This invention provides a method for processing phosphors for use in optical applications. The method includes providing a luminescent material in particulate form. The luminescent material has particles characterized by a particle size range. The luminescent material is filtered to remove particulates having a size greater than the upper limit of the desired particle size range. The method also includes dispensing a portion of the particles over a surface of an optical device. Alternatively, the dispensing technique may be implemented by deposition, forming, spraying, pasting, sputtering, or other suitable processes.

In an alternative embodiment, the invention provides a method for processing phosphors for use in optical applications. The method includes providing a luminescent material in particulate form having particles of a specific particle size range. The method includes subjecting the luminescent material to a cleaning solution in at least deionized water. Mechanical agitation helps remove ionic contaminants from the luminescent material surface. Then the cleaning solution is removed from the luminescent material and the luminescent material is dried to remove residual cleaning solution and organic contaminants from the luminescent material. Then the luminescent material can be applied over a surface region of an optical device.

The present invention enables manufacture of high efficiency conversion apparatus using luminescent materials, which have been treated. In a specific embodiment, an optical device can be manufactured in a relatively simple and cost effective manner.

The present invention is described in the context of known process technology and an optical device, but other devices can also be used. Such other devices include electrical devices, mechanical devices, and any combinations.

### BRIEF DESCRIPTION OF THE DRAWINGS

FIG. 1 is a diagram of luminescent material having particulate contamination;

FIG. 2 is a flow diagram of a method of filtering the luminescent material;

FIG. 3 is a mechanical filtering apparatus for processing phosphor particles;

FIG. 4 is a flow diagram of a method of cleaning the luminescent material;

FIG. 5 is a more detailed diagram of a system for cleaning the luminescent material;

FIG. 6 is a diagram of dispensing the luminescent material in a manufacture of an LED device;

FIG. 7 shows data comparing conventional luminescent material against the present luminescent material; and

FIG. 8 is a illustration of efficiency plotted against an average particle size of luminescent material.

### DETAILED DESCRIPTION OF THE INVENTION

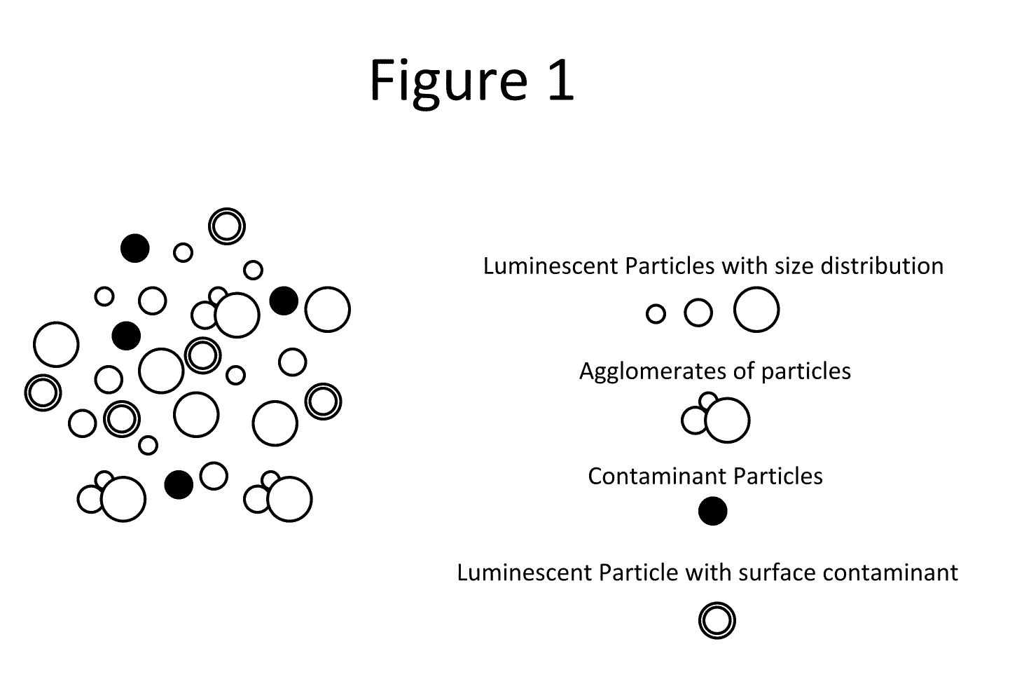

FIG. 1 is a diagram of luminescent material having particulate contamination. As shown, the collection of particle sizes and types varies. The term “particle” as used herein, includes both contaminants and luminescent particles, e.g., phosphors. In many examples, the contaminant particles are undesirable. In some cases, luminescent particles may also be undesirable if they fall outside of a certain size distribution. The particles also include luminescent particles with surface contaminants.

Also shown in the figure are contaminant particles. The collection may also include agglomerate particles, which also may include contaminants. In a specific example, the particles may have a size distribution ranging from 100 nanometers to about 100 micros, and can vary depending upon the embodiment. In this example, the method removes certain contaminant particles, and filters the luminescent particles to be within a selected size range. Alternatively or in combination, the method may also de-agglomerate larger sized particles to become smaller more desirable components.

A method according to the present embodiment is:
1. Start;
2. Provide a luminescent material in particulate form having a plurality of particles characterized by a desired particle size range, an undesirable particle size, and contaminants;
3. Subject the particles to a filtering process;
4. Selectively removing the particles having the undesirable size;
5. Provide the luminescent material within the desired size range;
6. Combine luminescent materials with encapsulation material using a high speed mixing process;
7. Dispense a portion of the luminescent material in the encapsulation overlying a surface region of an optical device; and
8. Perform other steps, as desired.

The method provides for filtering luminescent materials to selectively obtain particles within a certain desirable size distribution. The method includes a mechanical filtering of particles to remove undesirable sized particles.

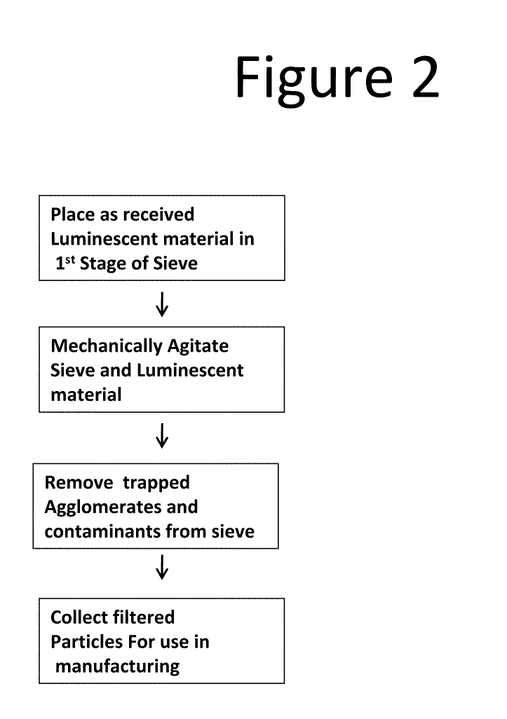

FIG. 2 is a flow diagram of a method of filtering the luminescent material. As shown is a method for cleaning luminescent materials and applying them for wavelength conversion purposes. The method begins at start. The method also provides a luminescent material in particulate form having a plurality of particles characterized by a desired particle size range, an undesirable particle size, and contaminants. In a specific embodiment, the desired particle size range one micron to about 30 microns, although there can be variations. The undesirable particle size is outside of this range and more particularly sizes of less than 1 microns. That is, it is unexpected that smaller particle sizes lead to more scattering, which leads to losses in the packaging, and the like. Larger size particles greater than 30 microns are often difficult to spread uniformly and process. The larger particles, however, are fairly efficient in conversion, and become more efficient as they become larger, but has drawbacks, again which are unexpected. That is, larger sized particles cannot be processed efficiently, lead to non-uniform layers, and other limitations.

The method also subjects the particles to a filtering process. The method selectively removes the particles having the undesirable size. The filtering process can be a mechanical filtering process. The process uses a mechanical filter with a plurality of openings, which selectively filter desirable sizes. The mechanical filter is often made of stainless steel, ceramic materials, or other suitable materials. The process occurs at room temperature or within other ranges. The process also includes agitation and/or vibration, which may range in movement from microns to millimeters. As an example, the frequency can range from about a cycle per second and greater to about 200 to 300 cycles per second. In this example the luminescent materials are now within the desired size range.

In an example, the filter process can be used to selectively remove smaller particles, which are undesirable, while the larger particles remain. Next, the filter process can remove the desirable sized particles, while leaving the larger undesirable sized particles in the filter structure. In this example, the filter process is two-step, but can also be more than two steps.

In a specific embodiment, contaminants are also removed. Contaminants are often flux residues. The residues include sodium, potassium, and other ionic materials, which are melt-assist flux agents. Other types of contaminants include cerium, aluminum, iron, molybdenum, or other metals. Contaminants also include organic contaminants, plastics, and other non-active materials.

In this example, the method combines luminescent materials with encapsulation material using a high speed mixing process. The encapsulation material can include silicones, epoxy, and other binding and/or filler materials. The mixing process creates a mixture where the luminescent materials are dispersed homogeneously through a volume of the encapsulation materials. The plurality of particles, characterizing the luminescent materials, have been dispersed through the volume of encapsulating to improve the efficiency of the wavelength conversion, while maintaining process efficiency.

The method also dispenses a portion of the luminescent material in the encapsulation overlying a surface region of an optical device. The encapsulating material configured with the plurality of luminescent materials that are disposed homogeneously to improve efficiently. In an example, the plurality of luminescent materials have less than about ten (10) percent particles that are smaller than a lower limit, which leads to scattering of electromagnetic radiation. The luminescent materials are also substantially free from contaminants, and other imperfections that lead to loss of efficiency.

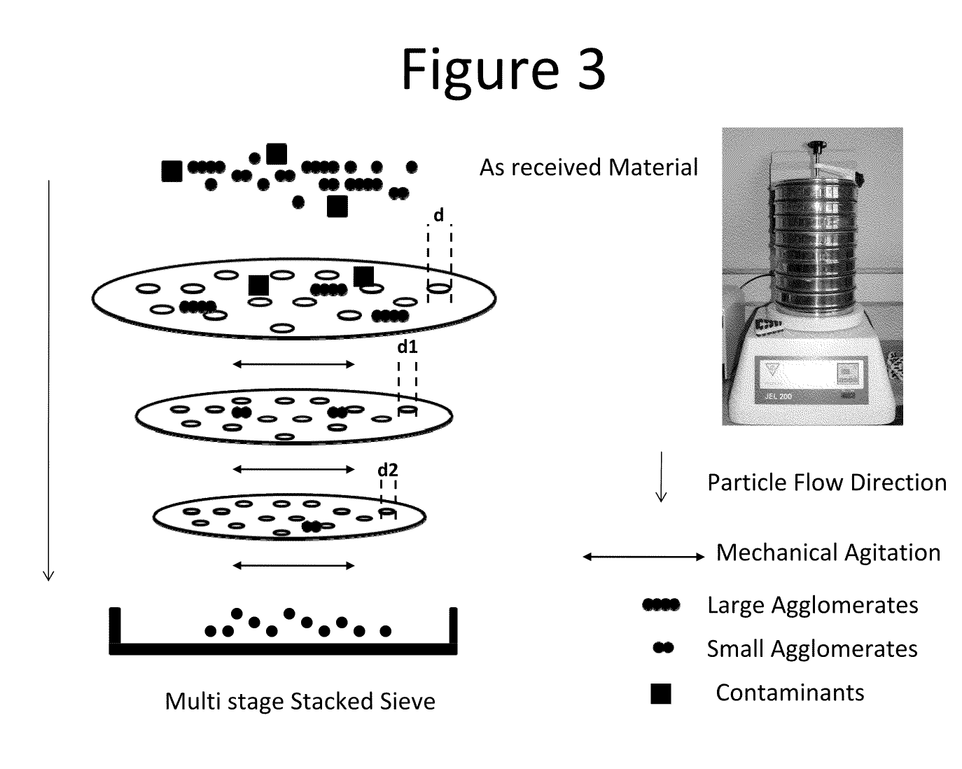

FIG. 3 depicts a mechanical filtering apparatus for processing phosphor particles according to an embodiment of the present invention. The apparatus includes a sieve coupled to an agitation device. The sieve is often exchanged for other sizes. The apparatus can be one manufactured such as the Meinzer II Sieve Shaker distributed by CSC Scientific Company, Inc., 2799-C Merrilee Drive, Fairfax Va., 22031, but can be others. As shown, the apparatus includes a plurality of mechanical filters, which are configured to remove (1) large contaminant particles; (2) larger sized undesirable particles; (3) smaller sized particles or micro-dust; and output particles within a desired size range. As shown, one filter removes contaminate particles, another filter removes larger sized particles to pass the desired particles and micro-dust, which is undesirable. A second filter holds the desired particles and passes the micro-dust or smaller sized particles. Of course, there can be variations, and alternatives. An example of the product specification is provided below.

Meinzer II Sieve Shaker

Compact: Only 250 mm diameter footprint

Height: 180 mm excl. sieve stack

Lightweight: Weighs only 36 lbs

Accommodates: Up to 8 full height 200 mm (8″) sieves

Location for 100 mm sieves

Timer: 0 to 60 minute or continuous

Power: Available in all standard voltages

e.g. 230V/50 Hz 110/60 Hz

Other Voltages available

A method according to the present embodiment is:
1. Start;
2. Provide a luminescent material in particulate form having a plurality of particles characterized by a desired particle size range, an undesirable particle size, and contaminants;
3. Subject the particles to a filtering process;
4. Selectively removing the particles having the undesirable size;
5. Subject the luminescent material to a cleaning solution, e.g., deionized water;
6. Optionally, subject the luminescent material in the cleaning solution to mechanical agitation in an alternative embodiment;
7. Cause removal of ionic contaminants from the luminescent material from at least the cleaning solution and/or the mechanical agitation;
8. Remove the cleaning solution from the luminescent material;
9. Subject the luminescent material free from the ionic contaminants to a drying process to remove both any residual amount of cleaning solution and an organic contaminant from the luminescent material;
10. Combine luminescent materials with encapsulation material using a high speed mixing process; and
11. Dispense a portion of the luminescent material in the encapsulation overlying a surface region of an optical device.

As shown, the present method provides a method for cleaning and filtering luminescent materials. The method includes a combination of mechanical filtering with contaminant removal using a solvent. Depending upon the embodiment, some of the above steps may be combined, other steps may be added, and one or more steps may be removed.

In an alternative specific embodiment, the present method is:

A method according to the present embodiment is briefly outlined below.
1. Start;
2. Provide a luminescent material in particulate form having a plurality of particles characterized by a desired particle size range, an undesirable particle size, and contaminants;
3. Subject the luminescent materials including the particles to a cleaning solution, e.g., solvent, water, alcohol.
4. Subject the luminescent materials including the particles within the cleaning solution to mechanical agitation, e.g., ultrasonic, stirring, mega-sonic.
5. Cause removal of contaminants among the luminescent materials;
6. Cause breakup of agglomerated particles from the luminescent materials to a size within the desired partical size range;
7. Release lower density contaminates into the cleaning solution;
8. Cause the lower density contaminates to rise to a surface region of the cleaning solution;
9. Remove the lower density contaminates by skimming the surface region of the cleaning solution or decanting the cleaning solution;
10. Remove the particles from the cleaning solution;
11. Dry the particles to remove any additional fluid from the particles;
12. Combine luminescent materials with encapsulation material using a high speed mixing process; and
13. Dispense a portion of the luminescent material in the encapsulation overlying a surface region of an optical device.

As shown, the present method provides a method for cleaning and filtering luminescent materials. The method includes a combination of mechanical filtering with contaminant removal using a solvent. Depending upon the embodiment, some of the above steps may be combined, other steps may be added, and one or more steps may be removed. Further details of the present method can be found throughout the present specification and more particularly below.

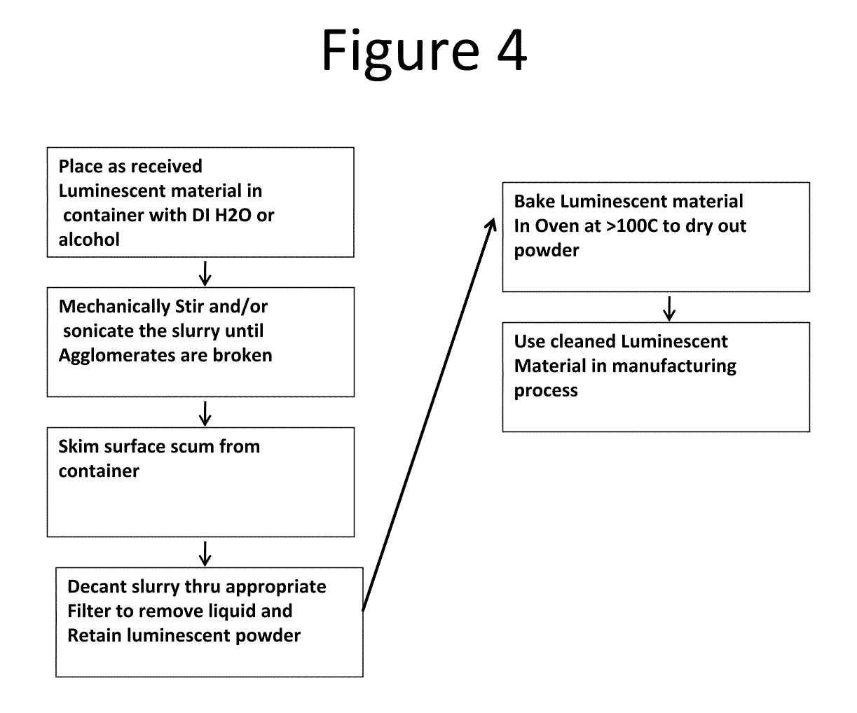

FIG. 4 is a flow diagram of a method of cleaning the luminescent material according to an embodiment of the present invention. As shown, the method provides a luminescent material in particulate form having a plurality of particles characterized by a desired particle size range, an undesirable particle size, and contaminants.

The method subjects the luminescent materials including the particles to a cleaning solution. As an example, the cleaning solution is a solvent such as water, alcohol, or other fluids, which may include additives and/or surfactants. The solution may also include emulsifiers, de-flocculants, or other materials that assist or enhance in the removal of contaminants from the luminescent materials.

The method subjects the luminescent materials including the particles within the cleaning solution to mechanical agitation. The cleaning solution is often in a bath or batch form. The bath is subject to energy, which is mechanical. The energy may be applied via an ultrasonic process, a stirring process, a mega-sonic process, or others. The bath may also be subjected to thermal treatment. The thermal treatment may cause an increase in temperature of the cleaning solution to enhance removal of contaminates. The increase in temperature can occur using a resistive heating element, irradiation, chemical heating, among others.

In a specific embodiment, the methods described causes removal of contaminants among the luminescent materials. The contaminants are often flux residues. The residues include sodium, potassium, and other ionic materials, which are melt-assist flux agents. Other types of contaminants include cerium, aluminum, iron, molybdenum, or other metals. Contaminants also include organic contaminants, plastics, and other non-active materials. Examples of contaminants may include the following, among others, including combinations thereof:

### Salt-Forming Cations Include:

Ammonium NH₄⁺
Calcium Ca²⁺
Iron Fe²⁺ and Fe³⁺
Magnesium Mg²⁺
Potassium K⁺
Pyridinium C₅H₅NH⁺
Quaternary ammonium NR₄⁺
Sodium Na⁺
   Salt-Forming Anions (Parent Acids in Parentheses where Available) Include:
Acetate CH₃COO⁻ (acetic acid)
Carbonate CO₃²⁻ (carbonic acid)
Chloride Cl⁻ (hydrochloric acid)
Citrate HOC(COO⁻)(CH₂COO⁻)₂ (citric acid)
Cyanide C≡N⁻ (N/A)
Hydroxide OH⁻ (N/A)
Nitrate NO₃⁻ (nitric acid)
Nitrite NO₂⁻ (nitrous acid)
Oxide O²⁻ (N/A)
Phosphate PO₄³ (phosphoric acid)
Sulfate SO₄²⁻ (sulfuric acid)

In a specific embodiment, the method may release lower density contaminates into the cleaning solution and causes the lower density contaminates to rise to a surface region of the cleaning solution. The lower density contaminates are removed by skimming the surface region of the cleaning solution or decanting the cleaning solution.

Additionally, the method causes breakup of agglomerated particles from the luminescent materials to a size within the desired particle size range. That is, larger sized particles are broken into smaller sized particles, which are within a desirable particle size range. Of course, there can be variations.

The method removes the particles from the cleaning solution once they have been cleaned. The method dries the particles to remove any additional fluid from the particles. Drying occurs using conduction, convention, or radiation. Preferably, drying occurs using vacuum ovens, which are maintained within a certain vacuum and temperature range.

In this example, the method combines luminescent materials with encapsulation material using a high speed mixing process. The encapsulation material can include silicones, epoxy, and other binding and/or filler materials. The mixing process creates a mixture where the luminescent materials are dispersed homogeneously through a volume of the encapsulation materials. The plurality of particles, characterizing the luminescent materials, have been dispersed through the volume of encapsulating to improve the efficiency of the wavelength conversion, while maintaining process efficiency.

In a specific embodiment, the method also dispenses a portion of the luminescent material in the encapsulation overlying a surface region of an optical device. The encapsulating material configured with the plurality of luminescent materials that are disposed homogeneously to improve efficiently. In an example, the plurality of luminescent materials have less than about ten (10) percent particles that are smaller than a lower limit, which leads to scattering of electromagnetic radiation. The luminescent materials are also substantially free from contaminants, and other imperfections that lead to loss of efficiency.

As shown, the present method provides a method for cleaning and filtering luminescent materials. The method includes a combination of mechanical filtering with contaminant removal using a solvent. Depending upon the embodiment, some of the above steps may be combined, other steps may be added, and one or more steps may be removed. Further details of the present method can be found throughout the present specification and more particularly below.

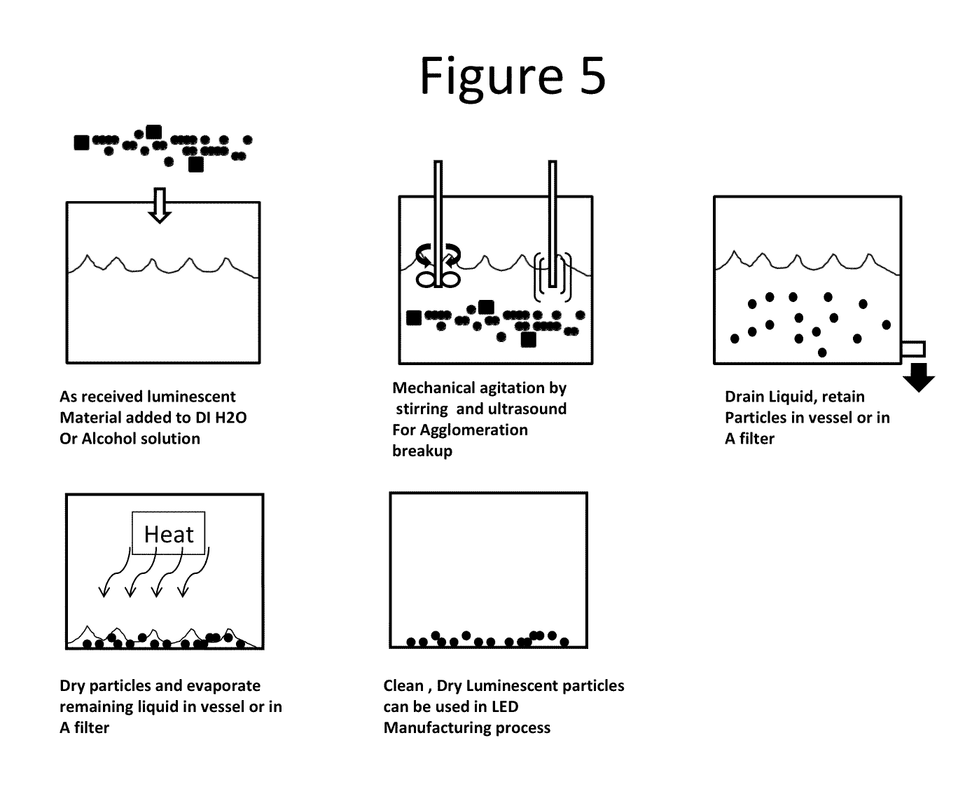

FIG. 5 is a more detailed diagram of a system for cleaning the luminescent material according to an embodiment of the present invention. As shown, the apparatus includes a bath, which holds the cleaning solution. The bath can be configured with filters, mechanical agitation devices, and others.

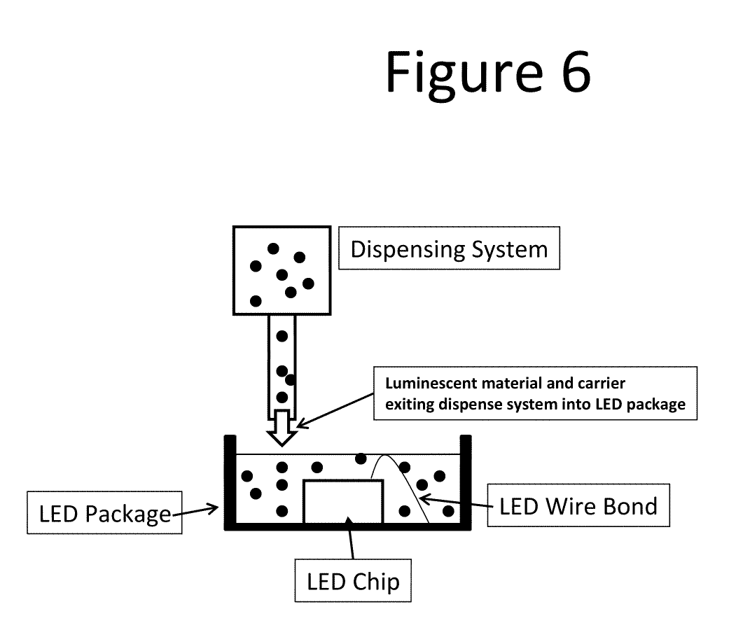

FIG. 6 is a diagram of dispensing the luminescent material in a manufacture of an LED device according to an embodiment of the present invention. As show, the dispensing occurs using a dispensing system. The dispensing system includes a dispenser, mixture, and platform, which holds an LED or optical device. The device includes a substrate, bonding wires, and encapsulating material with the luminescent particles therein.

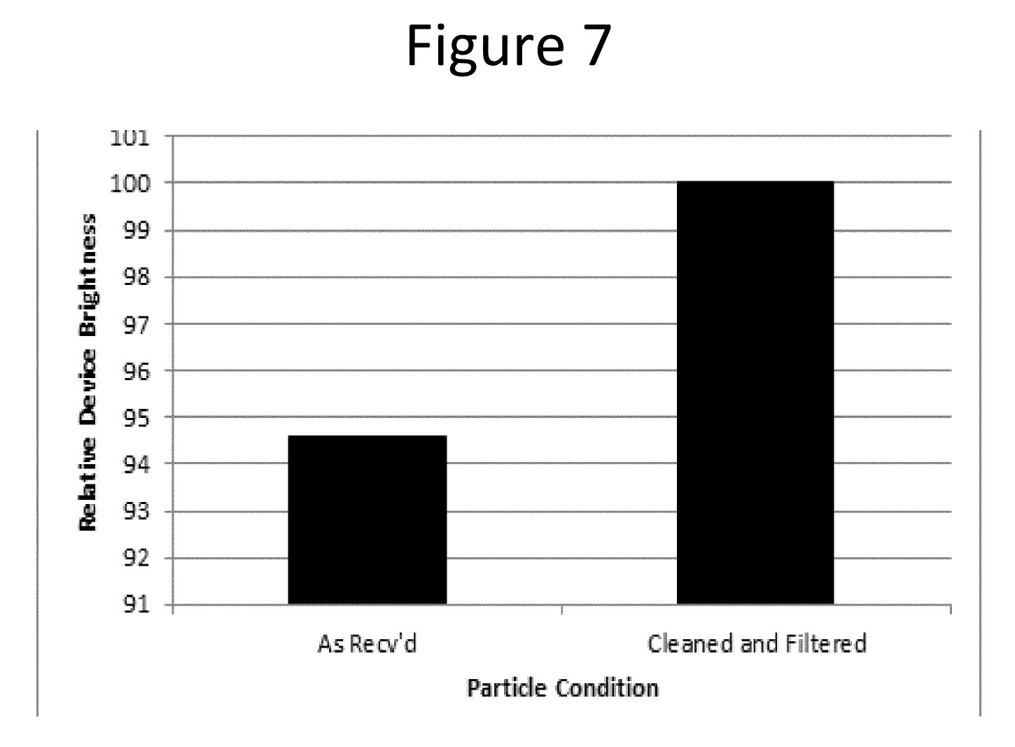

FIG. 7 shows data comparing conventional luminescent material against the present luminescent material. As shown, the vertical axis represents “Relative Device Brightness” and the horizontal axis represents “Particle Condition.” Clearly, the filtered/cleaned luminescent materials perform substantially better than the materials as received from a vendor. The better performance is unexpected and achieves higher efficiency conversion for the optical devices.

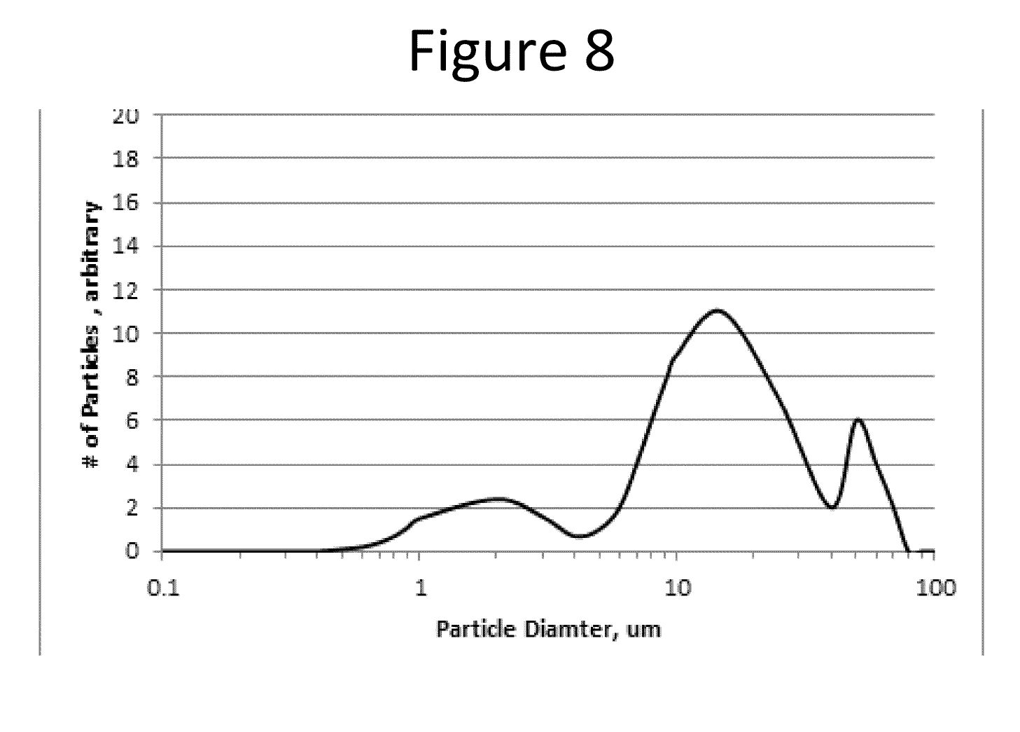

FIG. 8 is a plot of luminescent material particle size distribution. As shown, commercial luminescent materials include a varying distribution. The particles within a standard distribution of about 9 microns to 50 microns represent a desirable range. The particles outside of this distribution are undesirable. The smaller sized particles, although easier to process, lead to scattering and lower conversions, which are undesirable. The larger particles, although more efficient for conversion, lead to difficulty in processing. The present cleaning and filtering process selects the particles within the desirable size range.

In this example, the method uses one or more of the following luminescent materials. Wavelength conversion materials can be ceramic or semiconductor particle phosphors, ceramic or semiconductor plate phosphors, organic or inorganic downconverters, upconverters (anti-stokes), nano-particles and other materials which provide wavelength conversion. Some examples are listed below:

(Srₙ,Ca₁₋ₙ)₁₀(PO₄)₆*B₂O₃:Eu²⁺ (wherein 0≦n≦1)

### (Ba,Sr,Ca)₅(PO₄)₃(Cl,F,Br,OH):Eu²⁺,Mn²⁺

### (Ba,Sr,Ca)BPO₅:Eu²⁺,Mn²⁺

### Sr₂Si₃O₈*2SrCl₂:Eu²⁺

### (Ca,Sr,Ba)₃MgSi₂O₈:Eu²⁺, Mn²⁺

### BaAl₈O₁₃:Eu²⁺

### 2SrO*0.84P₂O₅*0.16B₂O₃:Eu²⁺

### (Ba,Sr,Ca)MgAl₁₀O₁₇:Eu²⁺,Mn²⁺

### K₂SiF₆:Mn⁴⁺

### (Ba,Sr,Ca)Al₂O₄:Eu²⁺

### (Y,Gd,Lu,Sc,La)BO₃:Ce³⁺,Tb³⁺

### (Ba,Sr,Ca)₂(Mg,Zn)Si₂O₇:Eu²⁺

(Mg,Ca,Sr,Ba,Zn)₂Si₁₋ₓO₄₋₂ₓ:Eu²⁺ (wherein 0≦x≦0.2)

### CaMgSi₂O₆:Eu²⁺

### (Sr,Ca,Ba)(Al,Ga)₂S₄:Eu²⁺

### (Ca,Sr)₈(Mg,Zn)(SiO₄)₄Cl₂:Eu²⁺,Mn²⁺

### Na₂Gd₂B₂O₇:Ce³⁺,Tb³⁺

### (Sr,Ca,Ba,Mg,Zn)₂P₂O₇:Eu²⁺,Mn²⁺

### (Gd,Y,Lu,La)₂O₃:Eu³⁺,Bi³⁺

### (Gd,Y,Lu,La)₂O₂S:Eu³⁺,Bi³⁺

### (Gd,Y,Lu,La)VO₄:Eu³⁺,Bi³⁺

### (Ca,Sr)S:Eu²⁺,Ce³⁺

(Y,Gd,Tb,La,Sm,Pr,Lu)₃(Sc,Al,Ga)₅₋ₙO_{12-3/2n}:Ce³⁺ (wherein 0≦n≦0.5)

### ZnS:Cu+,Cl−

### (Y,Lu,Th)₃Al₅O₁₂:Ce³⁺

### ZnS:Cu+,Al3+

### ZnS:Ag+,Al3+

### ZnS:Ag+,Cl−

### (Ca,Sr)Ga₂S₄:Eu²⁺

### SrY₂S₄:Eu²⁺

### CaLa₂S₄:Ce³⁺

### (Ba,Sr,Ca)MgP₂O₇:Eu²⁺,Mn²⁺

### (Y,Lu)₂WO₆:Eu³⁺,Mo⁶⁺

### CaWO₄

### (Y,Gd,La)₂O₂S:Eu³⁺

### (Y,Gd,La)₂O₃:Eu³⁺

(Ba,Sr,Ca)ₙSiₙNₙ:Eu²⁺ (where 2n+4=3n)

### Ca₃(SiO₄)Cl₂:Eu²⁺

(Y,Lu,Gd)₂₋ₙCaₙSi₄N₆₊ₙC₁₋ₙ:Ce³⁺, (wherein 0≦n≦0.5)
(Lu,Ca,Li,Mg,Y) alpha-SiAlON doped with Eu²⁺ and/or Ce³⁺

### (Ca,Sr,Ba)SiO₂N₂:Eu²⁺,Ce³⁺

### (Sr,Ca)AlSiN₃:Eu²⁺

### CaAlSi(ON)₃:Eu²⁺

### Sr₁₀(PO₄)₆Cl₂:Eu²⁺

### (BaSi)O₁₂N₂:Eu²⁺

M(II)ₐSi_{b}O_{c}N_{d}Ce:A wherein (6<a<8, 8<b<14, 13<c<17, 5<d<9, 0<e<2) and M(II) is a divalent cation of (Be,Mg,Ca,Sr,Ba,Cu,Co,Ni,Pd,Tm,Cd) and A of (Ce,Pr,Nd,Sm,Eu,Gd,Tb,Dy,Ho,Er,Tm,Yb,Lu,Mn,Bi,Sb)

### SrSi₂(O,Cl)₂N₂:Eu²⁺

### (Ba,Sr)Si₂(O,Cl)₂N₂:Eu²⁺

LiM₂O₈:Eu³⁺ where M=(W or Mo)

For purposes of the application, it is understood that when a phosphor has two or more dopant ions (i.e. those ions following the colon in the above phosphors), this is to mean that the phosphor has at least one (but not necessarily all) of those dopant ions within the material. That is, as understood by those skilled in the art, this type of notation means that the phosphor can include any or all of those specified ions as dopants in the formulation.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A method for processing phosphors for use in optical applications, the method comprising:
providing a luminescent material in particulate form, the luminescent material having a plurality of particles characterized by a desired particle size range and undesirable particle size range, the undesirable particle size range including a lower limit size and an upper limit size;
subjecting the luminescent material to a first filter process to remove particles having a size greater than the upper limit size to separate the plurality of particles characterized by the desired particle size range from the particles having the size greater than the upper limit size;
subjecting the luminescent material to a second filter process to remove particles having a size below the lower limit size to a fraction of ten (10) percent and less of a total weight of the luminescent material remaining from the first filter process and the second filter process;
combining the luminescent material after the first and second filter process with an encapsulant material in fluid form to cause a uniform distribution of the luminescent material within the encapsulant material; and
forming a thickness of the encapsulating material including the luminescent material within a vicinity of an optical device while the plurality of particles in the luminescent material remains uniformly distributed through the thickness of the encapsulating material, the luminescent material characterized by the undesirable particle size range at or below the lower limit size in the encapsulant material being less than about ten percent (10%) by weight of the total weight of the luminescent material remaining in the encapsulating material.

2. The method of claim 1 wherein the luminescent material is selected from one of a phosphor or a wavelength conversion material; wherein the forming comprises a dispensing process.

3. The method of claim 1 wherein the luminescent material is provided in a weight of at least 200 grams.

4. The method of claim 1 wherein the plurality of particles is substantially mixed with the encapsulating material.

5. The method of claim 1 wherein first filter process comprising using a metal filter to mechanically separate the particulates having a size greater than two times the upper limit from the plurality of particles.

6. The method of claim 1 wherein filter process comprising using a ceramic filter to mechanically separate the particulates having a size greater than two times the upper limit from the plurality of particles.

7. The method of claim 1 wherein filter process comprising using a mesh filter to mechanically separate the particulates having a size greater than two times the upper limit from the plurality of particles.

8. The method of claim 1 further comprising mechanically agitating a filter device during the filter process.

9. The method of claim 1 further comprising maintaining a desired temperature and a desired humidity during the filter process.

10. A method for processing phosphors for use in optical applications, the method comprising:
providing a luminescent material in particulate form, the luminescent material having a plurality of particles characterized by a desired particle size range;
subjecting the luminescent material to a cleaning solution, the cleaning solution comprising deionized water;
subjecting the luminescent material in the cleaning solution to mechanical agitation;
causing removal of contaminants from the luminescent material from at least the cleaning solution and the mechanical agitation;
removing the cleaning solution from the luminescent material;
subjecting the luminescent material free from the ionic contaminants to a drying process to remove both any residual amount of cleaning solution and contaminants from the luminescent material; and
dispensing a portion of the luminescent material overlying a surface region of an optical device.

11. The method of claim 10 wherein the luminescent material comprises a YAG-Ce3+ material.

12. The method of claim 10 wherein the luminescent material is provided in a weight of at least 200 grams.

13. The method of claim 10 wherein the portion of the luminescent material is mixed with an encapsulant material.

14. The method of claim 10 wherein the deionized water has a resistivity ranging from about 0.2 to 18 mega-Ohms-cm at 25° C.

15. The method of claim 10 wherein the contaminants comprise a salt, the salt selected from at least one of
Ammonium NH₄⁺
Calcium Ca²⁺
Iron Fe²⁺ and Fe³⁺
Magnesium Mg²⁺
Potassium K⁺
Pyridinium C₅H₅NH⁺
Quaternary ammonium NR₄⁺
Sodium Na⁺
Acetate CH₃COO⁻ (acetic acid)
Carbonate CO₃²⁻ (carbonic acid)
Chloride Cl⁻ (hydrochloric acid)
Citrate HOC(COO⁻)(CH₂COO⁻)₂ (citric acid)
Cyanide C≡N⁻ (N/A)
Hydroxide OH⁻ (N/A)
Nitrate NO₃⁻ (nitric acid)
Nitrite NO₂⁻ (nitrous acid)
Oxide O²⁻ (N/A)
Phosphate PO₄³⁻ (phosphoric acid) or
Sulfate SO₄²⁻ (sulfuric acid).

16. The method of claim 10 wherein the contaminant comprises a carbon bearing species including at least one of bonds containing C—H, C—C, C═C, C—O, or C—N.

17. The method of claim 10 wherein the mechanical agitation comprising a stirring process.

18. The method of claim 10 wherein the mechanical agitation comprises an ultrasonic process or a mega-sonic process to break a larger sized particle of the luminescent material into a smaller sized particle, the smaller sized particle being within the desired particle size range.

19. The method of claim 10 wherein the cleaning solution ranges in temperature from 20 C to 150 C.

20. The method of claim 10 further comprising subjecting the luminescent material to a filter process to remove particulates having a size greater than two times an upper limit of the desired particle size range to separate the plurality of particles characterized by the desired particle size range.
